(19) United States
(12) Patent Application Publication
(10) Pub. No.: US 2013/0052453 A1
(43) Pub. Date: Feb. 28, 2013

(54) THERMOPLASTIC POWDER COMPOSITION AND THREE-DIMENSIONAL OBJECTS MANUFACTURED BY SINTERING SUCH A COMPOSITION

(71) Applicants: Gregory Filou, Manneville sur Risle (FR); Frederic Malet, Rouen (FR); Arnaud Lemaitre, Saint Martin-Saint Firmin (FR); Cyrille Mathieu, Rouen (FR)

(72) Inventors: Gregory Filou, Manneville sur Risle (FR); Frederic Malet, Rouen (FR); Arnaud Lemaitre, Saint Martin-Saint Firmin (FR); Cyrille Mathieu, Rouen (FR)

(73) Assignee: Arkema France, Colombes (FR)

(21) Appl. No.: 13/522,825

(22) PCT Filed: Jan. 19, 2011
(86) PCT No.: PCT/FR2011/050089

§ 371 Date: Nov. 9, 2012

(30) Foreign Application Priority Data
Jan. 19, 2010 (FR) 1050329

(51) Int. Cl. B32B 5/30; B32B 5/16; B02C 19/18; B29C 45/72

(52) U.S. Cl. 428/327; 264/478; 428/402; 241/23

(57) ABSTRACT

The present invention relates to a thermoplastic powder composition with D50 lower than 100 μm, including: at least one block copolymer having a inciting temperature lower than 180° C.; 15 to 50 wt % of at least one powdery filler having Mohs hardness lower than 6 and D50 lower than 20 μm; and 0.1 to 5% of a powdery flow agent with D50 lower than 20 μm, relative to the total weight of the composition. The present invention relates in particular to the use of said composition in methods for agglomerating powder, layer by layer, by melting or sintering, in order to manufacture flexible three-dimensional objects.

The present invention relates to a thermoplastic powder composition, and its use in processes for layer-by-layer powder agglomeration, by melting or sintering, in order to manufacture flexible three-dimensional articles.

The expression “flexible articles” is understood, within the meaning of the invention, to mean articles that have an elastic modulus of less than 1000 MPa (measured according to the standard ISO 527-2: 93-1BA).

The agglomeration of powders by melting (which is referred to hereinbelow as “sintering”) is brought about by radiation such as, for example, a laser beam (laser sintering), infrared radiation, UV radiation or any source of electromagnetic radiation that makes it possible to melt the powder layer by layer in order to manufacture articles. The technology of manufacturing articles layer by layer is described in particular in patent application WO 2009/138692 (pages 1 to 3). This technology is generally used to produce prototypes and models of parts (“rapid prototyping”) or to produce small runs of final products (“rapid manufacturing”), for example in the motor vehicle, nautical, aeronautics, aerospace, medical (prostheses, auditive systems, cell tissues, etc.), textile, clothing, fashion, decorative, electronic casing, telephony, home automation, information technology and lighting sectors. The present invention more particularly concerns the sports market, where thermoplastic elastomer polymers (abbreviated to TPE below) are generally chosen for their flexibility, their dynamic properties and their physico-chemical resistance. These TPEs are easy to process via the conventional processes of injection moulding, extrusion, moulding and/or joining. Layer-by-layer sintering processes require a prior conversion of these TPEs into the form of powders.

These powders must be suitable for being used in sintering devices and must allow the manufacture of flexible parts that have satisfactory properties, especially in terms of density. Indeed, some materials produced by powder sintering may contain a residual degree of porosity. The true density of the material is then less than its theoretical density. The insufficient surface density of the material also results in an uneven surface appearance and imprecise edges of the article. Many properties (mechanical, thermal) of the final article depend on the degree of porosity of the material. It is therefore important to be able to quantify these parameters by measuring the true density of the material of the article obtained by sintering.

In the present description, the true density of an article manufactured by sintering a powder composition is compared, as a percentage, to the theoretical density (corresponding to 100%) defined as the density of a three-dimensional article of the same shape manufactured by a process of injection moulding the same composition. The density is measured according to the standard ISO 1183. Document U.S. Pat. No. 6,110,411 describes thermoplastic powder compositions that can be used in laser sintering processes. The powder compositions from this document must have a glass transition temperature (T_{g}) below 50° C., a weight ratio of the hard blocks to the soft blocks ranging from 0.7 to 20, and a particle size of less than 200 μm. Nevertheless, the parts obtained by sintering these compositions have insufficient resolution and insufficient density, as mentioned in document WO 2005/025839. Indeed, the parts obtained according to document U.S. Pat. No. 6,110,411 have numerous “voids”, and their density is typically within the range extending from 60 to 80% of the theoretical density, which is insufficient for the applications targeted by the present invention.

In order to increase the density of the parts obtained by current processes for sintering TPE powders, the parts must be subjected to a subsequent step of infiltration into the voids or gaps (residual porosity) of the part, by a polymer in liquid form, for example a polyurethane oligomer, followed by a step of crosslinking the polymer in the part. These subsequent steps increase the manufacturing time and cost of the parts. In order to improve the density of the three-dimensional articles obtained by sintering TPE powders while avoiding these subsequent infiltration steps, document WO 2005/025839 proposes a TPE-based powder composition having a melting temperature (Tₘ) above 180° C. However, currently, there is no alternative other than infiltration for increasing the density of flexible articles formed by sintering TPE-based powders having a melting temperature below 180° C.

The objective of the present invention is therefore to provide a sinterable pulverulent thermoplastic composition having a Tₘ below 180° C., which makes it possible to obtain, by sintering, three-dimensional articles which have:
a density greater than 80% of the theoretical density (density measured according to the standard ISO 1183), which does not therefore require infiltration,
good flexibility, that is to say an elastic modulus of less than 1000 MPa (measured according to the standard ISO 527-2: 93-1BA), and
good definition, namely a smooth and homogeneous even surface appearance, and precise edges.

Another objective of the present invention is to provide a process for manufacturing articles, which are flexible, dense and have good resolution, directly by sintering.

One subject of the present invention is therefore a thermoplastic powder composition having a D50 of less than 100 μm, comprising:
at least one block copolymer having a melting temperature below 180° C. (abbreviated below to Tₘ<180° C.);
from 15 to 50% by weight of at least one pulverulent filler having a Mohs hardness of less than 6 and having a D50 of less than 20 μm; and
from 0.1 to 5% of a pulverulent flow agent having a D50 of less than 20 μm;
   out of the total weight of the composition.

Another subject of the present invention is a process for manufacturing a powder composition according to the invention, comprising the following steps:

a) mixing, by compounding, of said at least one block copolymer having Tₘ<180° C. with said at least one filler;

b) cryomilling of the mixture obtained in a) in order to obtain a powder having a D50 of less than 100 μm with a yield of greater than 50%; then

c) adding the flow agent to the powder obtained in to).

Another subject of the present invention is the use of 15 to 50% by weight of filler having a Mohs hardness of less than 6 and having a D50 of less than 20 μm in a thermoplastic powder having a D50 of less than 100 μm which comprises at least one block copolymer, in order to manufacture, by sintering, an article having a density greater than 80% of the theoretical density defined as the density of an article of the same shape manufactured by injection moulding the same composition.

The D50 corresponds to the value of particle size which divides the particle population examined exactly in half. In other words, in the composition according to the invention, 50% of the particles have a size of less than 100 μm. The D50 of less than 100 μm of the composition according to the invention is essential for obtaining an article of precise definition, and of smooth and even surface appearance. The D50 is measured according to the standard ISO 9276—parts 1 to 6: “Representation of data obtained by particle size analysis”. In the present description, a laser particle size analyser (Sympatec Helos) and software (Fraunhofer) are used to obtain the particle size distribution of the powder and to deduce the D50 therefrom.

The expression “block copolymer according to the invention” is understood to mean the thermoplastic elastomer polymers (TPEs), which comprise, alternately, blocks or segments said to be hard or rigid (having rather thermoplastic behaviour) and blocks or segments said to be soft or flexible (having rather elastomeric behaviour). A block is said to be “soft” if it has a low glass transition temperature (T_{g}). The expression “low glass transition temperature” is understood to mean a glass transition temperature T_{g} below 15° C., preferably below 0° C., advantageously below −15° C., more advantageously below −30° C., possibly below −50° C.

The soft or flexible blocks that can be envisaged in the copolymer according to the invention, are understood in particular to be those chosen from polyether blocks, polyester blocks, polysiloxane blocks, such as polydimethylsiloxane or PDMS blocks, polyolefin blocks, polycarbonate blocks, and mixtures thereof. The soft blocks that can be envisaged are described for example in French patent application No.: 0950637, page 32 line 3 to page 38, line 23. By way of example, the polyether blocks are chosen from poly(ethylene glycol) (PEG), poly(1,2-propylene glycol) (PPG), poly(1,3-propylene glycol) (PO3G), poly(tetramethylene glycol) (PTMG) and copolymers or blends thereof. Preferably, the number-average molecular weight Mₙ of the soft blocks according to the invention is within the range extending from 250 to 5000 g/mol, preferably from 250 to 3000 g/mol, and more preferably from 500 to 2000 g/mol.

The hard blocks may be based on polyamide, polyurethane, polyester or a blend of these polymers. These blocks are in particular described in French patent application No.: 0856752. The hard blocks are preferably based on polyamide. The polyamide (abbreviated to PA) blocks may comprise homopolyamides or copolyamides. The polyamide blocks that can be envisaged in the composition of the invention are in particular those defined in application FR0950637, from page 27, line 18 to page 31, line 14. Preferably, the number-average molecular weight Mₙ of the polyamide blocks is within the range extending from 400 to 20 000 g/mol, preferably from 500 to 10 000 g/mol, and more preferably from 600 to 3000 g/mol. As examples of polyamide blocks, mention may be made of those comprising at least one of the following molecules: PA-12, PA-11, PA-10,10, PA-6,10, PA-6, PA-6/12, a copolyamide comprising at least one of the following monomers: 11, 5,4, 5,9, 5,10, 5,12, 5,13, 5,14, 5,16, 5,18, 5,36, 6,4, 6,9, 6,10, 6,12, 6,13, 6,14, 6,16, 6,18, 6,36, 10,4, 10,9, 10,10, 10,12, 10,13, 10,14, 10,16, 10,18, 10,36, 10,T, 12,4, 12,9, 12,10, 12,12, 12,13, 12,14, 12,16, 12,18, 12,36, 12,T and blends or copolymers thereof.

Advantageously, said at least one block copolymer comprises at least one block chosen from: polyether blocks, polyester blocks, polyamide blocks, polyurethane blocks, and mixtures thereof. By way of example of a copolymer having hard blocks and soft blocks, mention may respectively be made of (a) copolymers having polyester blocks and polyether blocks (also known as COPEs or copolyetheresters), (b) copolymers having polyurethane blocks and polyether blocks (also known as TPUs, an abbreviation for thermoplastic polyurethanes) and (c) copolymers having polyamide blocks and polyether blocks (also known as PEBAs according to IUPAC, or else polyether-block-amides).

Preferably, said at least one copolymer comprises a copolymer having polyamide blocks and polyether blocks (PEBA). Advantageously, said PEBA comprises PA-12/PEG, PA-6/PEG, PA-6/12/PEG, PA-11/PEG, PA-12/PTMG, PA-6/PTMG, PA-6/12/PTMG, PA-11/PTMG, PA-12/PEG/PPG, PA-6/PEG/PPG, PA-6/12/PEG/PPG, PA-11/PEG/PPG, PA-11/PO3G, PA-6,10/PO3G and/or PA-10,10/PO3G. In the present description, and by convention in the field of the manufacture of three-dimensional articles by powder agglomeration by melting, the melting temperature (Tₘ) of the polymer powder corresponds to the melting temperature during first heating (Tₘ₁) of the powder. It is measured according to the standard ISO 11357-3 Plastics—Differential scanning calorimetry (DSC) Part 3. The block copolymer has a melting temperature Tₘ (of first heating: Tₘ₁) of less than 180° C. The use of such copolymers having Tₘ<180° C. in the composition of the invention makes it possible to obtain, especially by sintering, three-dimensional articles having improved flexibility (modulus of less than 1000 MPa) compared to the parts obtained by sintering polyamide PA-12 or PA-11 powders for example.

According to one particular embodiment of the invention, the weight ratio of the hard blocks to the soft blocks of the copolymer according to the invention is less than 0.7. This makes it possible to obtain three-dimensional articles of even better flexibility, for example having a modulus of elasticity of less than 100 MPa and an elongation at break greater than 100%, measured according to the standard ISO 527-2: 93-1BA.

The pulverulent fillers in the composition according to the invention have a Mohs hardness of less than 6. This is because pulverulent fillers having a Mohs hardness greater than or equal to 6 would be difficult to use in the invention, in particular the cryogenic milling thereof would be impossible and the milling device would be damaged. The Mohs hardness scale is based on ten readily available minerals. It is an ordinal scale, from which a comparison (ability of one to scratch the other) is made with two other minerals, the hardnesses of which are already known.

Moreover, the pulverulent fillers used in the present invention have a D50 of less than 20 μm. It has been observed that fillers having a D50 of greater than 20 μm have a negative impact on the flowability of the powder under standard laser sintering conditions.

The pulverulent fillers according to the invention may be of mineral or organic origin, and may be used alone or as a mixture. The fillers used in the compositions according to the present invention may be in the form of lamellae, globules, spheres, fibres or any other form intermediate between these defined forms. The fillers may or may not be surface-coated, and in particular they may be surface-treated with silicones, amino acids, fluorinated derivatives or any other substance that promotes the dispersion and the compatibility of the filler in the composition.

Advantageously, said at least one filler is chosen from: carbonate-based mineral fillers, calcium carbonate, magnesium carbonate, dolomite, calcite, barium sulphate, calcium sulphate, dolomite, kaolin, talc, micro-mica, alumina hydrate, wollastonite, montmorillonite, zeolite, perlite, nanofillers (fillers of nanometre scale), such as nanoclays or carbon nanotubes; pigments, such as titanium dioxide, especially rutile or anatase titanium dioxide; transition metal oxides; graphite, carbon black, the silica, alumina, phosphate, borate, silicate; organic fillers, such as polymer powders, especially those having a modulus greater than 1000 MPa. Pulverulent organic fillers are preferably chosen from powders of polymers, copolymers, elastomers, thermoplastics or thermosets, used alone or as a mixture.

Mineral fillers are preferred since they generally also play a reinforcing role in the composition according to the invention. Furthermore, mineral fillers make it possible to achieve, via cryomilling, the particle size (D50<100 μm) desired for the composition, more easily than with organic fillers. Advantageously, said at least one pulverulent filler is a mineral filler having a D50 of less than 10 μm. Advantageously, said at least one pulverulent filler comprises calcium carbonate and/or magnesium carbonate. Preferably, the composition according to the invention comprises dolomite.

The pulverulent filler(s) represent(s) from 15 to 50% by weight of the composition according to the invention. A filler content of less than 15% is not sufficient to reduce the D50 of the powder during cryomilling. Conversely, too high a filler content, of greater than 50% in the composition, ruins the elastomeric mechanical properties of the final material obtained by sintering the composition, in particular the elongation at break of the material becomes less than 100%. Preferably, said at least one pulverulent filler represents from 15 to 35% by weight, preferably from 20 to 30% by weight, out of the total weight of the composition. These preferred filler contents optimize both the D50 of the powder composition of the invention, its processing via sintering, and also the density and the definition of the final article, as shown by the examples below. The composition of the invention also comprises a flow agent in a sufficient amount (which represents from 0.1 to 5% by weight of the composition) so that the composition flows and forms a flat layer, especially during a layer-by-layer sintering process. The flow agent is chosen from those commonly used in the field of polymer powder sintering. Preferably, this flow agent is of substantially spherical shape. It is for example chosen from: silicas, precipitated silicas, hydrated silicas, vitreous silicas, fumed silicas, pyrogenic silicas, vitreous phosphates, vitreous borates, vitreous oxides, amorphous alumina, titanium dioxide, talc, mica, kaolin, attapulgite, calcium silicates, alumina and magnesium silicates.

The compositions according to the invention may of course also comprise any type of additive suitable for the polymer powders used in sintering: especially additives which help to improve the properties of the powder for its use in agglomeration technology and/or additives that make it possible to improve the mechanical properties (tensile strength and elongation at break) or aesthetic properties (colour) of the articles obtained by melting. The composition of the invention may especially comprise dyes, colouring pigments, TiO₂, pigments for infrared absorption, carbon black, fire retardants, glass fibres, carbon fibres, etc. The compositions of the invention may also contain at least one additive chosen from antioxidants, light stabilizers, impact modifiers, antistatic agents, flame retardants, and mixtures thereof. These additives are in the form of a powder having a D50 of less than 20 μm. The introduction of these additives during the process for manufacturing the powder composition according to the invention makes it possible to improve their dispersion and their efficacy. A sintering process using a composition according to the invention makes it possible to directly obtain coloured parts with no subsequent coating or painting operation. Another subject of the present invention is the use of a thermoplastic powder composition as defined previously in a sintering process for manufacturing an article having a density greater than 80% of the theoretical density defined as the density of an article of the same shape manufactured by a process of injection moulding said composition.

One subject of the present invention is in particular a process for manufacturing a three-dimensional article having a density greater than 80% of the theoretical density, comprising the layer-by-layer sintering of a powder having a composition according to the invention, said process not comprising a subsequent step of infiltration of material into said article manufactured by sintering.

Preferably, said process uses laser sintering.

The present invention relates to a three-dimensional article capable of being manufactured according to the process described previously, said article having a density of greater than 80% of the theoretical value. Advantageously, said article does not comprise material infiltrated into possible gaps or porosities of the article. Advantageously, the article according to the invention has an elastic modulus of less than 1000 MPa measured according to the standard ISO 527-2: 93-1BA.

Advantageously, said three-dimensional article is a component of sports equipment, of a shoe, of a sports shoe, of a shoe sole, of decorations, of luggage, of spectacles, of furniture, of audiovisual equipment, of a computer, of motor vehicle or aeronautic equipment and/or a component of medical equipment.

### EXAMPLES

The examples below illustrate the present invention without, however, limiting the scope thereof. In the examples, unless otherwise indicated, all the percentages and parts are expressed by weight.

Copolymers (Pebax® from Arkema) used in the compositions of the tests (examples and comparative examples) below:

Pebax 1: PEBA based on PA-11 blocks of Mₙ=600 g/mol and on PTMG blocks of Mₙ=1000 g/mol; the hard block/soft block ratio: 0.6.

Pebax 2: PEBA based on PA-11 blocks of Mₙ=1000 g/mol and on PTMG blocks of Mₙ=1000 g/mol; the hard block/soft block ratio: 1.

Pebax 3: PEBA based on PA-12 blocks of Mₙ=1000 g/mol and on PTMG blocks of Mₙ=1000 g/mol; the hard block/soft block ratio: 1.

Although the tests refer to a composition based on PEBA (Pebax®), it is clearly understood that the compositions according to the present invention are not limited to this embodiment, but may comprise any type of block copolymer, alone or as a blend.

The pulverulent filler used is dolomite (supplier: Imerys): double carbonate of calcium and magnesium, of chemical composition CaMg(CO₃)₂. Its Mohs hardness is 3. Its D50 is less than 10 μm.

The amount de filler used (% by weight) varies depending on the compositions of the examples and comparative examples (from 0 to 30%, see Table 2).

The flow agent used in all the tests below is the fumed silica CabOSil TS610 (supplier: Cabot Corporation), it represents 0.2% by weight in each composition. Its D50 is less than 20 μm.

### Examples 1 to 4 and Comparative Examples 1 to 3

### Manufacture of the Compositions of the Tests from Table 2

### Compounding:

In the tests from Table 2 which comprise the pulverulent filler (comparative Example 3, Examples 1, 2, 3, 4), granules of Pebax 1, 2 or 3 are compounded by extrusion (Werner 40 apparatus) with an amount of filler (respectively 10%, 20%, 30% and 22% of dolomite).

### Cryomilling:

Pebax 1 (Comparative Example 1 or 2) or Pebax 2 (Comparative Example 4), or the compound obtained previously (Comparative Example 3 and Examples 1 to 4) is cryomilled in order to target the manufacture of a powder having a D50<100 μm (Mikropul D2H cryogenic mill, a hammer mill with the following characteristics: motor speed: 2930 rpm, mill pulley diameter: 115 mm, motor pulley diameter: 270 mm, mill speed: 6870 rpm when empty, motor speed of the twin screws: 1360 rpm, reduction ratio of the twin screws: 1/10, diameter of the twin screws: 78 mm, pitch of the twin screws: 50 mm).

After cryomilling, the powders may optionally be dried in a rotary-drum oven (Heraeus, Jouanin) (temperature of 60° C., pressure of 20-25 mbar) for 8 hours.

### Screening:

After cryomilling, the powders are screened in order to remove the large particles and reduce the average size and the D50 of the particles (Perflux screen, stainless steel wire gauze, the meshes of which are 200 μm in all the tests, 145 μm for the additional screening of Comparative Example 2 only and 110 μm for Example 4.

### Measurement of the Screening Efficiency:

The efficiency represents the ratio (as a percentage) of the amount (by weight) of cryomilled powder passed through the meshes of the screen to the amount of powder inserted.

The powder obtained after cryomilling and screening then has 0.2% by weight of fumed silica (Cab-O-Sil TS610) added thereto.

Passage of the Compositions Obtained into a Sintering Machine:

A Formiga P100 (EOS) laser sintering machine is used.

The conditions for passage into the laser machine, which are fixed and common to all the compositions, are: contour speed=1500 mm/s, hatching speed=2500 mm/s, “beam offset” hatching=0.15 mm.

The conditions that vary according to the tests from Table 2 are indicated in Table 1 below:

TABLE 1

| | Exposure | Shrinkage | Laser power | Laser power |
|---|---|---|---|---|
| | chamber | chamber | for the | for the |
| | temperature | temperature | contour | hatching |
| | (° C.) | (° C.) | (watt) | (watt) |
| Comparative | 105 | 80 | 13 | 19 |
| Example 1 | | | | |
| Comparative | 105 | 80 | 13 | 19 |
| Example 2 | | | | |
| Comparative | 98 | 80 | 13 | 19 |
| Example 3 | | | | |
| Example 1 | 98 | 80 | 13 | 19 |
| Example 2 | 98 | 80 | 13 | 19 |
| Comparative | 127 | 105 | 12 | 18 |
| Example 4 | | | | |
| Example 3 | 120 | 99 | 12 | 18 |
| Example 4 | 120 | 99 | 12 | 18 |

The parts manufactured by sintering the various compositions are, in all the tests, tensile test specimens, which are dumbbells having dimensions of 150×25×3 mm.

### Surface Appearance of the 3D Articles Obtained:

In the column “Surface appearance” from Table 2, “OK” corresponds to an even, smooth and homogeneous surface appearance with precise edges. “KO” corresponds to the opposite appearance: in particular a degraded surface appearance.

### Measurement of the Density of the Three-Dimensional Articles (Test Specimens) Obtained:

The true density of each test specimen formed by laser sintering is measured according to the standard ISO 1183, and compared to the theoretical density of the corresponding test specimen of the same shape and of the same composition but manufactured by injection moulding. The true density/theoretical density ratio in Table 2 indicates whether the part obtained by laser sintering has a density of less than or greater than 80% of the theoretical density.

### Measurement of the Modulus of Elasticity (Tensile Modulus) of the Dumbbells Obtained by Sintering:

The tensile modulus is measured according to the standard ISO 527-2:93-1B.

For all the tests a modulus of less than 1000 MPa is obtained.

The screening efficiency, the particle size of the powder processed by sintering, the surface appearance, the true density/theoretical density ratio and the modulus of the 3D articles obtained are summarized in Table 2 below.

TABLE 2

| | | | Screening | | | True | |
|---|---|---|---|---|---|---|---|
| | | | efficiency | Particle | | density/ | Tensile |
| | Block | % Filler | (<200 μm) after | Size | Surface | theoretical | modulus |
| | copolymer | (Dolomite) | cryomilling | (D50) | appearance | density | (MPa) |
| Comparative | Pebax 1 | 0% | >50% | 105 μm | KO | <80% | <1000 |
| Example 1 | | | | | | | |
| Comparative | | 0% | <50% after | 80 μm | OK | >80% | <100 |
| Example 2 | | | additional | | | | |
| | | | screening | | | | |
| | | | (<145 μm) | | | | |
| Comparative | | 10% | >50% | 104 μm | KO | <80% | <100 |
| Example 3 | | | | | | | |
| Example 1 | | 20% | >50% | 84 μm | OK | >80% | <100 |
| Example 2 | | 30% | >50% | 69 μm | OK | >80% | <100 |
| Comparative | Pebax 2 | 0% | >50% | 114 μm | KO | <80% | <1000 |
| Example 4 | | | | | | | |
| Example 3 | | 22% | >50% | 61 μm | OK | >80% | <1000 |
| Example 4 | Pebax 3 | 22% | >50% | 70 μm | OK | 90% | >100 and |
| | | | | | | | <1000 |

### Comparative Example 1

Granules of Pebax 1 polymer (hard blocks/soft blocks ratio: 0.6 and melting temperature of first heating Tₘ₁: 146° C.) are cryomilled and screened to 200 μm. The powder obtained then has 0.2% by weight of flow agent (Cab-O-Sil TS610 fumed silica) added thereto. The powder composition, having a D50 equal to 105 μm, is processed by laser sintering (Formiga P100 laser machine) to construct three-dimensional parts (tensile test specimens). The parts obtained have a density of less than 80% of the theoretical density, an uneven surface appearance and an imprecise definition of the edges.

### Comparative Example 2

Granules of Pebax 1 polymer (hard blocks/soft blocks ratio: 0.6 and melting temperature of first heating Tₘ₁: 146° C.) are cryomilled and screened to 200 μm, then screened to 145 μm. The powder obtained then has 0.2% by weight of flow agent (Cab-O-Sil TS610 fumed silica) added thereto. The powder, having a D50 equal to 80 μm, is processed by laser sintering (Formiga P100 laser machine) to construct three-dimensional parts (tensile test specimens). The parts obtained have a density of greater than 80% of the theoretical density, an even, smooth and homogeneous surface appearance and precise edges. But the cryomilling yield (less than 50%) of powder having a D50 of less than 100 μm is not industrially viable. The powder composition of Comparative Example 2 thus cryomilled requires two screening steps, which leads to a loss of more than 50% (“screen oversize” of greater than 50%) of the powder resulting from the cryomilling.

### Comparative Example 3

Granules of Pebax 1 polymer (hard blocks/soft blocks ratio: 0.6 and melting temperature of first heating Tₘ₁: 146° C.) are compounded with 10% by weight of mineral filler (dolomite). The compound obtained is cryomilled and screened to 200 μm. The powder obtained then has 0.2% by weight of flow agent (Cab-O-Sil TS610 fumed silica) added thereto. The powder composition, having a D50 equal to 104 μm, is processed by laser sintering (Formiga P100 laser machine) to construct three-dimensional parts (tensile test specimens). The parts obtained have a density of less than 80% of the theoretical density, an uneven surface appearance and an imprecise definition of the edges.

### Example 1

Granules of Pebax 1 polymer (hard blocks/soft blocks ratio: 0.6 and melting temperature of first heating Tₘ₁: 146° C.) are compounded with 20% by weight of mineral filler (dolomite). The compound obtained is cryomilled and screened to 200 μm. The powder obtained then has 0.2% by weight of flow agent (Cab-O-Sil TS610 fumed silica) added thereto. The powder composition, having a D50 equal to 84 μm, is processed by laser sintering (Formiga P100 laser machine) to construct three-dimensional parts (tensile test specimens). The parts obtained have a density of greater than 80% of the theoretical density, an even, smooth and homogeneous surface appearance and precise edges.

### Example 2

Granules of Pebax 1 polymer (hard blocks/soft blocks ratio: 0.6 and melting temperature of first heating Tₘ₁: 146° C.) are compounded with 30% by weight of mineral filler (dolomite). The compound obtained is cryomilled and screened to 200 μm. The powder obtained then has 0.2% by weight of flow agent (Cab-O-Sil TS610 fumed silica) added thereto. The powder composition, having a D50 equal to 69 μm, is processed by laser sintering (Formiga P100 laser machine) to construct three-dimensional parts (tensile test specimens). The parts obtained have a density of greater than 80% of the theoretical density, an even, smooth and homogeneous surface appearance and precise edges.

### Comparative Example 4

Granules of Pebax 2 polymer (hard blocks/soft blocks ratio: 1 and melting temperature of first heating Tₘ₁: 148° C.) are cryomilled and screened to 200 μm. The powder obtained then has 0.2% by weight of flow agent (Cab-O-Sil TS610 fumed silica) added thereto. The powder composition, having a D50 equal to 114 μm, is processed by laser sintering (Formiga P100 laser machine) to construct three-dimensional parts (tensile test specimens). The parts obtained have a density of less than 80% of the theoretical density, an uneven surface appearance and an imprecise definition of the edges.

### Example 3

Granules of Pebax 2 polymer (hard blocks/soft blocks ratio: 1 and melting temperature of first heating Tₘ₁: 148° C.) are compounded with 22% by weight of mineral filler (dolomite). The compound obtained is cryomilled and screened to 200 μm. The powder obtained then has 0.2% by weight of flow agent (Cab-O-Sil TS610 fumed silica) added thereto. The powder composition, having a D50 equal to 61 μm, is processed by laser sintering (Formiga P100 laser machine) to construct three-dimensional parts (tensile test specimens). The parts obtained have a density of greater than 80% of the theoretical density, an even, smooth and homogeneous surface appearance and precise edges.

### Example 4

Granules of Pebax 3 polymer (hard blocks/soft blocks ratio: 1 and melting temperature of first heating Tₘ₁: 147° C.) are compounded with 22% by weight of mineral filler (dolomite). The compound obtained is cryomilled and screened (110 μm screen). The powder obtained then has 0.2% by weight of flow agent (Cab-O-Sil TS610 fumed silica) added thereto. A mineral pigment is also added (0.3% of Monarch 120 Black). The powder composition, having a D50 equal to 70 μm, is processed by laser sintering (Formiga P100 laser machine) to construct three-dimensional parts (tensile test specimens). The parts obtained have a density of 90% of the theoretical density, an even, smooth and homogeneous surface appearance and precise edges.

The processing of a powder composition according to the invention in Examples 1 to 4, by a laser sintering process makes it possible to directly obtain flexible parts of good definition and having a density greater than 80% of the theoretical value, with no subsequent (infiltration type) operation.

1. Thermoplastic powder composition having a D50 of less than 100 μm, comprising:
at least one block copolymer having a melting temperature below 180° C.;
from 15 to 50% by weight of at least one pulverulent filler having a Mohs hardness of less than 6 and having a D50 of less than 20 μm; and
from 0.1 to 5% of a pulverulent flow agent having a D50 of less than 20 μm;
out of the total weight of the composition.

2. Composition according to claim 2, in which said at least one block copolymer comprises at least one block chosen from: polyether blocks, polyester blocks, polyamide blocks, polyurethane blocks, and mixtures thereof.

3. Composition according to claim 1, in which said at least one copolymer comprises a copolymer having polyamide blocks and polyether blocks.

4. Composition according to claim 1, in which the flow agent is chosen from: silicas, hydrated silicas, amorphous alumina, vitreous silicas, vitreous phosphates, vitreous borates, vitreous oxides, titanium dioxide, talc, mica, fumed silicas, pyrogenic silicas, kaolin, attapulgite, calcium silicates, alumina and magnesium silicates.

5. Composition according to claim 1, in which said at least one pulverulent filler is chosen from: carbonate-based mineral fillers, calcium carbonate, magnesium carbonate, dolomite, calcite, barium sulphate, calcium sulphate, dolomite, kaolin, talc, micro-mica, alumina hydrate, wollastonite, montmorillonite, zeolite, perlite, nanofillers, nanoclays, carbon nanotubes, pigments, such as titanium dioxide, especially rutile or anatase titanium dioxide; transition metal oxides; graphite, carbon black, the silica, alumina, phosphate, borate, silicate, organic fillers, polymer powders, polymer powders having a modulus greater than 1000 MPa.

6. Composition according to claim 1, in which said at least one pulverulent filler is a mineral filler having a D50 of less than 10 μm.

7. Composition according to claim 1, in which said at least one pulverulent filler comprises calcium carbonate and/or magnesium carbonate.

8. Composition according to claim 1, in which said at least one filler represents from 15 to 35% by weight, preferably from 20 to 30% by weight, out of the total weight of the composition.

9. Composition according to claim 1, in which said at least one block copolymer comprises soft blocks and hard blocks, the ratio by weight of the hard blocks to the soft blocks being less than 0.7.

10. Process for manufacturing a powder composition according to claim 1, comprising the following steps:
a) mixing, by compounding, of said at least one block copolymer with said at least one filler;
b) cryomilling of the mixture obtained in a) in order to obtain a powder having a D50 of less than 100 μm with a yield of greater than 50%; then
c) adding the flow agent to the powder obtained ink).

11. In a sintering process manufacturing a three-dimensional article having a density greater than 80% of the theoretical density, defined as the density of an article of the same shape manufactured by a process of injection moulding said composition, the improvement comprising sintering a thermoplastic powder composition according to claim 1.

12. A method of producing a three-dimensional article having a density greater than 80% of the theoretical density defined as the density of an article of the same shape manufactured by injection moulding the same composition comprising sintering 15 to 50% by weight of a powder composition comprising a filler having a Mohs hardness of less than 6 and having a D50 of less than 20 μm in a thermoplastic powder having a D50 of less than 100 μm which comprises at least one block copolymer.

13. Process for manufacturing a three-dimensional article having a density greater than 80% of the theoretical density, comprising the layer-by-layer sintering of a powder having a composition according to claim 1, said process not comprising a subsequent step of infiltration of material into said article manufactured by sintering.

14. Flexible three-dimensional article capable of being manufactured according to the process of claim 13, said article having a density greater than 80% of the theoretical density.

15. Article according to claim 14, characterized in that it does not comprise material infiltrated into possible gaps in the article.

16. Article according to claim 14, having an elastic modulus of less than 1000 MPa measured according to the standard ISO 527-2: 93-1BA.

17. Article according to claim 14, said article being a component of sports equipment, of a shoe, of a sports shoe, of a shoe sole, of decorations, of luggage, of spectacles, of furniture, of audiovisual equipment, of a computer, of motor vehicle or aeronautic equipment and/or a component of medical equipment.
